(19) United States
(12) Patent Application Publication
(10) Pub. No.: US 2013/0008325 A1
(43) Pub. Date: Jan. 10, 2013

(54) MULTI-LINKAGE PRESS

(76) Inventors: Yu-Ting LIN, Kaohsiung (TW); Tsung-Jen Chang, Kaohsiung (TW); Pin-Jyun Chen, Kaohsiung (TW); I-Chen Lin, Kaohsiung (TW); Chih-Hao Lin, Wandan Township (TW)

(21) Appl. No.: 13/470,305

(22) Filed: May 12, 2012

(30) Foreign Application Priority Data
Jul. 8, 2011 (TW) 100124275

(51) Int. Cl. B30B 1/06

(52) U.S. Cl. 100/285

(57) ABSTRACT

A multi-linkage press contains a power transmission mechanism includes a rotary shaft driven by a power source; at least two eccentric wheel mechanisms including at least two eccentric wheels, each of the eccentric wheels including a crank sliding set to drive a first sliding block connected with a connecting rod; at least two multi-link mechanisms axially connected on the connecting rod and axially connected with two leveraged linkage assemblies; a sliding assembly including a slidable body with at least four longitudinal plungers, the four longitudinal plungers being axially connected with the two leveraged linkage assemblies to drive a slidable body to operate vertically, and between two of the four longitudinal plungers being connected a first connecting pillar, between another two of the four longitudinal plungers being connected a second connecting pillar, between the first connecting pillar and the second connecting pillar being coupled an axial shank.

### BACKGROUND OF THE INVENTION

1. Field of the Invention

The present invention relates to a multi-linkage press which is capable of enhancing an anti-eccentric load capacity by ways of a four-point force.

2. Description of the Prior Art

With reference to FIG. 1, a conventional press disclosed in TW Patent No. 92209468 comprises a guide seat 10, an eccentric device 11, two swing arms 12, two extensions 13, two pillars 14, two pegs 15, and an upper die 16. The guide seat 10 includes a first groove 101 formed on an upper side thereof and fitted with a first post 102, and a second groove 103 fitted with a second post 104 so that the guide seat 10 operates vertically along the first post 102 and the second post 104. The eccentric device 11 includes an eccentric wheel 111 and a transmission arm 112, and the eccentric wheel 111 is axially in connection with a lower end of the transmission arm 112, and an upper end of the transmission arm 112 is axially coupled with a coupling rod 113, two ends of which are connected on the guide seat 10 so that the eccentric wheel 111 drives the transmission arm 112, and the guide seat 10 moves vertically in a reciprocate manner along the first post 102 and the second post 104 via the coupling rod 113. The two ends of the coupling rod 113 are also fixed on the guide seat 10. One ends of the two swing arm 12 are connected with an end portion of the coupling rod 112, and another ends thereof are axially coupled with one ends of the two extension 13, the two extensions 13 are pivoted on a machine frame to swing in a leverage manner, another ends of the two extensions 13 are axially joined with the two pillars 12, another ends of the two pillars 14 are axially connected with the two pegs 15 on the upper die 16. As shown in FIG. 2, when the eccentric wheel 111 of the eccentric device 11 operates to move the guide seat 10 upward linearly, the two pillars 12 push the two extensions 13 to swing in the leverage manner to drive the two pillars 14 to swing and to push the two pegs 15 to move downward so that the upper die 16 punches a workpiece, having a reciprocate punching operation.

Referring further to FIG. 2, when the upper die 16 punches the workpiece, the two pillars 14 drive the two pegs 15 to force downward, and a two-point force on two sides of the upper die 16 punches the workpiece, but if a material feeding and discharging is in process on a left side and a right side of the punch, an anti-eccentric load capacity on the left side and the right side of the punch are enhanced. However, if the material feeding and discharging is in process on a front side and a rear side of the punch or a forming load is not distributed equally (such as an unequal punched shape on the front side and the rear side of the punch or a progress deforming), the anti-eccentric load capacity becomes poor, so the upper die 16 can not operate in the same parallelism, affecting punching accuracy.

The present invention has arisen to mitigate and/or obviate the afore-described disadvantages.

### SUMMARY OF THE INVENTION

The primary object of the present invention is to provide a multi-linkage press which is capable of enhancing an anti-eccentric load capacity by ways of a four-point force to maintain operation accuracy and enhance punching quality.

Secondary object of the present invention is to provide a multi-linkage press which is capable of lowering the load length of the rotary shaft such that a deflection of a load of the two eccentric wheel mechanisms on the two sides of the rotary shaft is then decreased to enhance a precision of a dead point in a punching operation.

Further object of the present invention is to provide a multi-linkage press which is capable of eliminating inertia force and the vibration to obtain dynamic equilibrium and keep operation accuracy.

Another object of the present invention is to provide a multi-linkage press in which a movement feature of the slidable body is achieved by designing a length and a size of the first swing arm, the second swing arms, the second extension, the third extension, and the fourth extension, thereby providing a design flexibility.

To obtain the above objectives, a multi-linkage press provided by the present invention contains:

a power transmission mechanism includes a rotary shaft driven to rotate by a power source;

at least two eccentric wheel mechanisms including at least two eccentric wheels arranged on the rotary shaft, and each of the at least two eccentric wheels including a crank sliding set pivoted thereon to drive a first sliding block pivoted thereon to move vertically, and the first sliding block being connected with a connecting rod;

at least two multi-link mechanisms axially connected on the connecting rod of the at least two eccentric wheel mechanisms and axially connected with two leveraged linkage assemblies;

a sliding assembly including a slidable body, and the slidable body including at least four longitudinal plungers mounted on an upper side thereof, the four longitudinal plungers being axially connected with the two leveraged linkage assemblies of the at least two multi-link mechanisms to drive a slidable body to operate vertically in a reciprocate moving manner, and between two of the four longitudinal plungers being connected a first connecting pillar, and between another two of the four longitudinal plungers being connected a second connecting pillar, between the first connecting pillar and the second connecting pillar being coupled an axial shank to increase a rigid restraint of the four longitudinal plungers.

### BRIEF DESCRIPTION OF THE DRAWINGS

FIG. 1 is a plan view showing of a conventional press disclosed in TW Patent. No. 92209468;

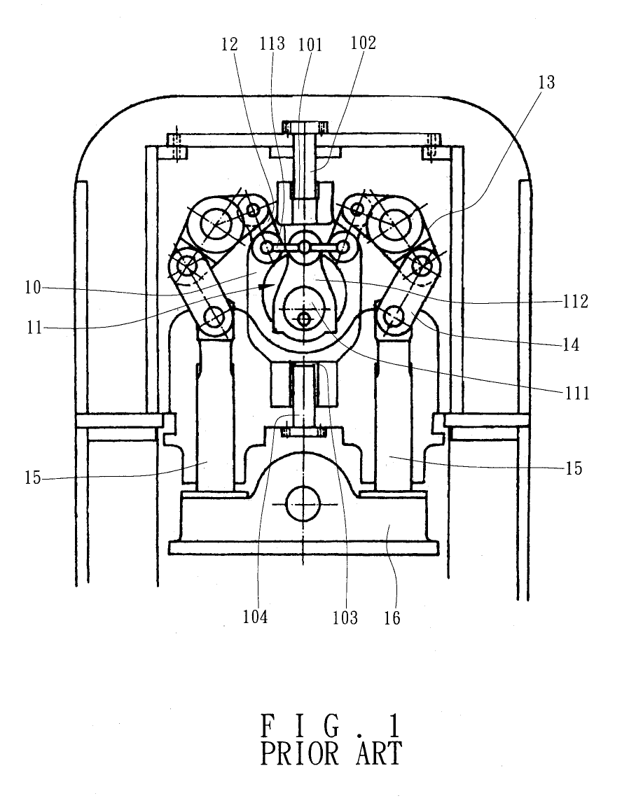

FIG. 2 is another plan view showing of a conventional press disclosed in TW Patent. No. 922094680;

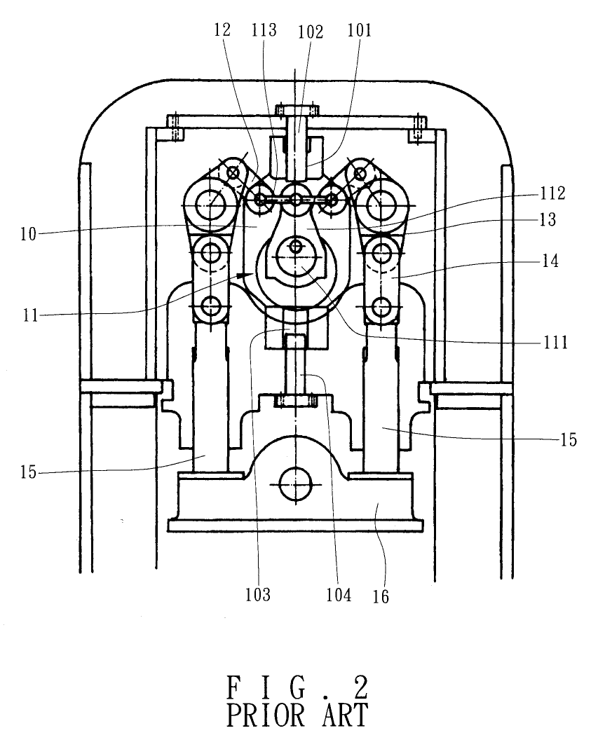

FIG. 3 is a perspective view showing the assembly of a multi-linkage press according to a preferred embodiment of the present invention;

FIG. 4 is a perspective view showing a part of the exploded components of the multi-linkage press according to the preferred embodiment of the present invention;

FIG. 5 is a cross sectional view showing the assembly of the multi-linkage press according to the preferred embodiment of the present invention;

FIG. 6 is another cross sectional view showing the assembly of the multi-linkage press according to the preferred embodiment of the present invention;

FIG. 7 is a cross sectional view showing the operation of the multi-linkage press according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

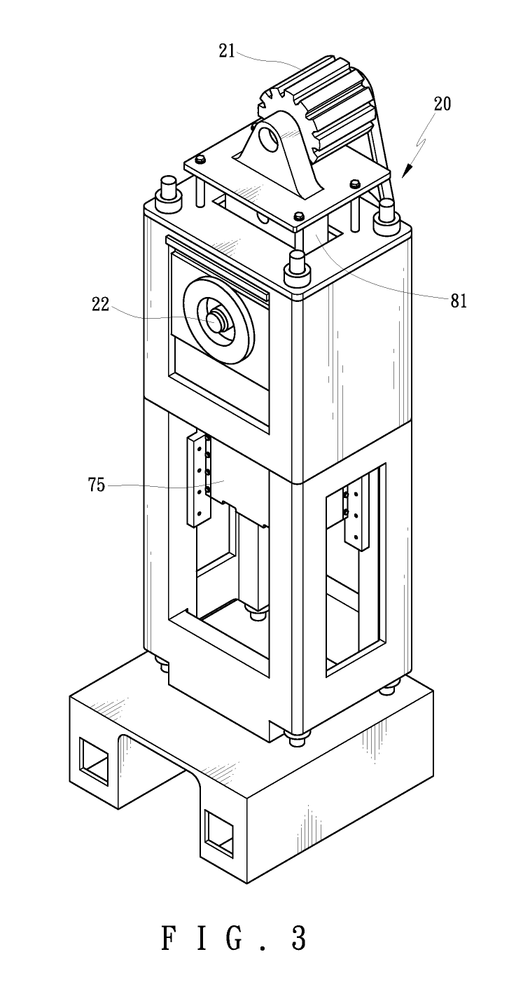

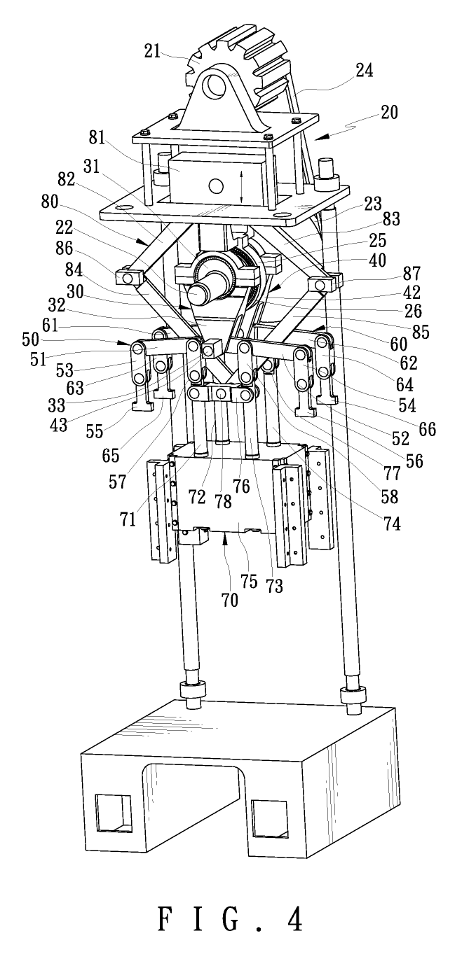

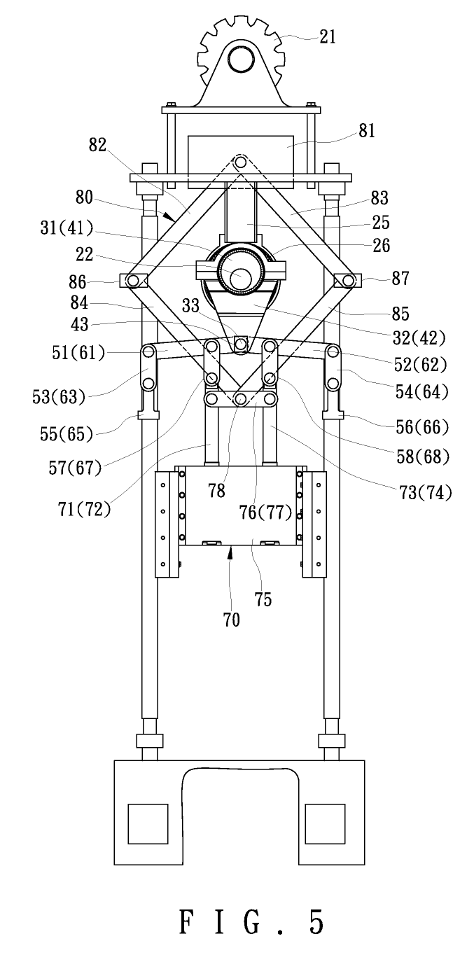

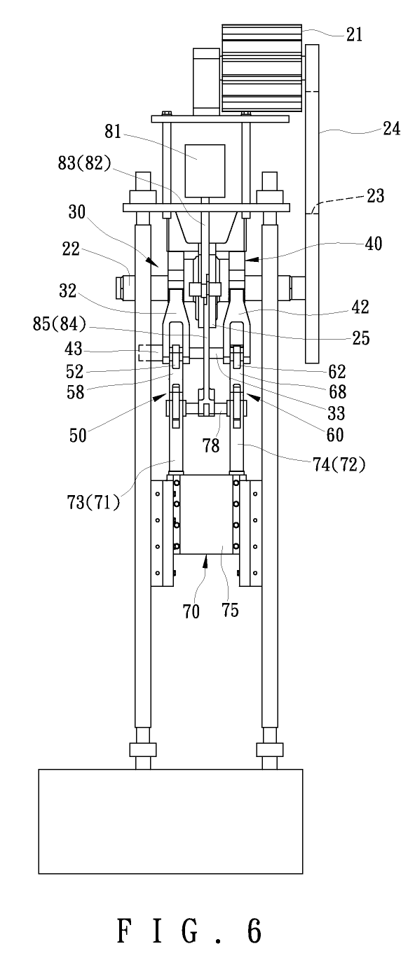

Referring to FIGS. 3-6, a multi-linkage press according to the present patent comprises a power transmission mechanism 20, two eccentric wheel mechanisms 30, 40, two multi-link mechanisms 50, 60, a sliding assembly 70, and a parallel four-link balancing mechanism 80. The power transmission mechanism 20 drives a rotary shaft to rotate by ways of a power source. In this embodiment, the power transmission mechanism 20 includes a motor 21 disposed above a machine frame, a rotary shaft 22 fixed on the machine frame, a flywheel 23 mounted on one end of the rotary shaft 22, a belt 24 to drive the motor 21 by which the rotary shaft 22 is driven to rotate. The two eccentric wheel mechanisms 30, 40 include a first eccentric wheel 31 and a second eccentric wheel 41, both of which are arranged on two sides of the rotary shaft 22, and each of the first eccentric wheel 31 and the second eccentric wheel 41 includes a crank sliding set pivoted thereon. In this embodiment, the crank sliding set of the first eccentric wheel 31 includes a first actuating rod 32 pivoted thereon, and the crank sliding set of the second eccentric wheel 41 includes a second actuating rod 42 pivoted thereon, and another end of each of the first actuating rod 32 and the second actuating rod 42 includes a first sliding block 43 pivoted thereon to move vertically on the machine frame. In this embodiment, another ends of the first actuating rod 32 and the second actuating rod 42 include a connecting rod 33 fitted thereon, and the connecting rod 33 includes the first sliding block 43 pivoted thereon, the first sliding block 43 is also fixed in a vertical groove of the machine frame so that when the rotary shaft 22 drives the first eccentric wheel 31 and the second eccentric wheel 41 to rotate, the connecting rod 33 and the first sliding block 43 are driven to move vertically by using a movement of the first actuating rod 32 and the second actuating rod 42, and the connecting rod 33 of the first actuating rod 32 and the second actuating rod 42 is driven by a single power source to have a reciprocately vertical movement. Since the two sides of the rotary shaft 22 have the two eccentric wheel mechanisms 30, 40 fixed thereon, to lower a load length, between the two eccentric wheel mechanisms 30, 40 is defined a holder 25 in this embodiment, and the holder 25 is also disposed on an upper side of the machine frame and has a bearing sleeve 26 for receiving the rotary shaft 22 to lower the load length of the rotary shaft 22 such that a deflection of a load of the two eccentric wheel mechanisms 30, 40 on the two sides of the rotary shaft 22 is then decreased to enhance a precision of a dead point in a punching operation. The two multi-link mechanisms 50, 60 are axially connected on the connecting rod 33 of the another ends of the first actuating rod 32 and the second actuating rod 42 and are also axially connected with two leveraged linkage assemblies, and each of the leveraged linkage assemblies is axially joined with four longitudinal plungers 71, 72, 73, 74 of the sliding assembly 70 so that when the connecting rod 22 operates vertically in a reciprocate moving manner, the two multi-link mechanisms 50, 60 drive the two leveraged linkage assemblies, so that the four longitudinal plungers 71, 72, 73, 74 of the sliding assembly 70 are driven by the two leveraged linkage assemblies to move vertically, thus enhancing an anti-eccentric load capacity by ways of a four-point force. In this embodiment, the two leveraged linkage assemblies of the two multi-link mechanisms 50, 60 include two first swing arms 51, 61 pivoted on the connecting rod 33 and two second swing arms 52, 62 pivoted on the connecting rod 33 as well. Another ends of the two first swing arms 51, 61 are axially coupled with two first extensions 53, 63 and two second extensions 54, 64, and the two first extensions 53, 63 and the two second extensions 54, 64 are pivoted on the machine frame. In this embodiment, the two first extensions 53, 63 are axially connected on two first fixing members 55, 65 of the machine frame, and the two second extensions 54, 64 are axially connected on two second fixing members 56, 66 of the machine frame. The two first swing arms 51, 61 include two third extensions 57, 67 axially connected therewith and defined between the connecting rod 33 and the two first extensions 53, 63, and the two second swing arms 52, 62 include two fourth extensions 58, 68 axially connected therewith and defined between the connecting rod 33 and the two second extensions 54, 64. The two third extensions 57, 67 and the two fourth extensions 58, 68 are axially coupled with the four longitudinal plungers 71, 72, 73, 74 of the sliding assembly 70 so as to obtain the four-point force to drive the sliding assembly 70 to move vertically. In this embodiment, the sliding assembly 70 includes a slidable body 75 fixed on the machine frame, and the slidable body 75 includes the four longitudinal plungers 71, 72, 73, 74 mounted on an upper side thereof and pivoted on the two third extensions 57, 67 and the two fourth extensions 58, 68, so that when the connecting rod 33 operates vertically in the reciprocate moving manner, the two leveraged linkage assemblies of the two multi-link mechanisms 50, 60 drive the four longitudinal plungers 71, 72, 73, 74 of the sliding assembly 70 to move vertically so that an anti-eccentric load capacity on a top surface of the slidable body 75 is enhanced by ways of the four-point force. To increase a rigid restraint of the four longitudinal plungers 71, 72, 73, 74, between two of the four longitudinal plungers 71, 72 is connected a first connecting pillar 76, and between another two of the four longitudinal plungers 73, 74 is connected a second connecting pillar 77, between the first connecting pillar 76 and the second connecting pillar 77 is coupled an axial shank 78 so that when the slidable body 75 is effected by an eccentric load in the punching operation, the rigid restraint of the four longitudinal plungers 71, 72, 73, 74 is increased, thus keeping the slidable body 75 in the same parallelism in the punching operation. It is to be noted that after one of the two multi-link mechanisms 50 or 60 is axially connected with the slidable body 75, an eight linkage mechanism is formed, a movement feature of the slidable body 75 is achieved by designing a length and a size of the first swing arm 51(61), the second swing arms 52(62), the second extension 54(64), the third extension 57(67), and the fourth extension 58(68), thereby providing a design flexibility. To eliminate inertia force and vibration in the punching operation, the multi-linkage press of the present invention further comprises the parallel four-link balancing mechanism 80. In this embodiment, the parallel four-link balancing mechanism 80 includes a counterweight member 81, a first peg 82 and a second peg 83, both of which are axially connected on a lower end of the counterweight member 81, a third peg 84 axially coupled with another end of the first peg 82, and a fourth 85 axially joined with another end of the second peg 83, the third peg 84 and the fourth peg 85 are axially connected with the connecting rod 33 or the axial shank 78. In this embodiment, the third peg 84 and the fourth peg 85 are axially connected with the axial shank 78, and two pivot points of the first peg 82 and the third peg 84 are pivoted on a second sliding block 86 for laterally sliding, and two pivot points of the second peg 83 and the fourth peg 85 are pivoted on a third sliding block 87 for laterally sliding such that the counterweight member 81 keeps operation in an opposite direction to the slidable body 75, hence the inertia force and the vibration is eliminated by the slidable body 75.

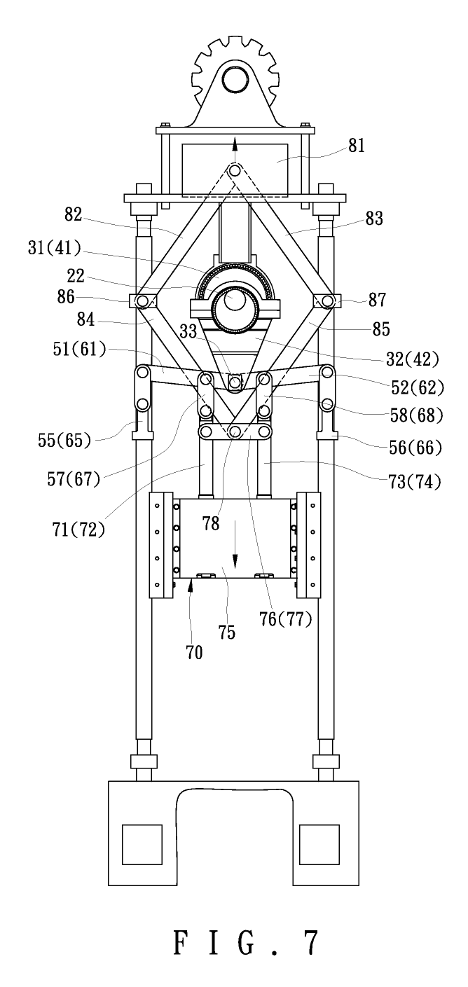

Referring further to FIG. 7, the rotary shaft 22 drives the first eccentric wheel 31 and the second eccentric wheel 41 to rotate, and the connecting rod 33 of the first actuating rod 32 and the second actuating rod 42 moves downward, thereafter the connecting rod 33 presses one ends of the two first swing arms 51, 61 and one ends of the two first fixing members 55, 65, the two first fixing members 55, 65 and the two second fixing members 52, 62 are used as fulcrums so that the two first swing arms 51, 61 and the second swing arms 52, 62 axially rotate downward in a leverage manner. In the meantime, the third swing arms 57, 67 and the fourth swing arms 58, 68 drive the four longitudinal plungers 71, 72, 73, 74 of the slidable body 75 to move downward to the dead point so that the slidable body 75 moves downward by ways of the four-point force, thus having the punching operation. Thereby, an equal surface force forms on the slidable body 75 because of a four-point force on the slidable body 75 to enhance the anti-eccentric load capacity of the slidable body 75, maintaining operation accuracy and enhancing punching quality. When the four longitudinal plungers 71, 72, 73, 74 drive the axial shank 78 between the first connecting pillar 76 and the second connecting pillar 77 to move downward, the axial shank 78 drives the third peg 84 and the fourth peg 85 to axially rotate downward, and the second sliding block 86 and the third sliding block 87 slide inward to the machine frame so that first peg 82 and the second peg 83 axially rotate upward to drive the counterweight member 81 to lift upward so as to operate in the opposite direction to the slidable body 75, hence the inertia force and the vibration is eliminated by the slidable body 75, thus obtaining dynamic equilibrium and keeping operation accuracy.

While we have shown and described various embodiments in accordance with the present invention, it is clear to those skilled in the art that further embodiments may be made without departing from the scope of the present invention.

What is claimed is:

1. A multi-linkage press comprising:
a power transmission mechanism includes a rotary shaft driven to rotate by a power source;
at least two eccentric wheel mechanisms including at least two eccentric wheels arranged on the rotary shaft, and each of the at least two eccentric wheels including a crank sliding set pivoted thereon to drive a first sliding block pivoted thereon to move vertically, and the first sliding block being connected with a connecting rod;
at least two multi-link mechanisms axially connected on the connecting rod of the at least two eccentric wheel mechanisms and axially connected with two leveraged linkage assemblies;
a sliding assembly including a slidable body, and the slidable body including at least four longitudinal plungers mounted on an upper side thereof, the four longitudinal plungers being axially connected with the two leveraged linkage assemblies of the at least two multi-link mechanisms to drive a slidable body to operate vertically in a reciprocate moving manner, and between two of the four longitudinal plungers being connected a first connecting pillar, and between another two of the four longitudinal plungers being connected a second connecting pillar, between the first connecting pillar and the second connecting pillar being coupled an axial shank to increase a rigid restraint of the four longitudinal plungers.

2. The multi-linkage press as claimed in claim 1, wherein the power transmission mechanism includes a motor disposed above a machine frame, the rotary shaft fixed on the machine frame, a flywheel mounted on one end of the rotary shaft, a belt to drive the motor by which the flywheel is driven to drive the rotary shaft to rotate.

3. The multi-linkage press as claimed in claim 1, wherein the power transmission mechanism further includes a holder between the at least two eccentric wheels of the rotary shaft, and the holder is also disposed on an upper side of the machine frame and has a bearing sleeve for receiving the rotary shaft.

4. The multi-linkage press as claimed in claim 1, wherein the at least two eccentric wheel mechanisms includes a first eccentric wheel and a second eccentric wheel, both of which are arranged on two sides of the rotary shaft, and each of the first eccentric wheel and the second eccentric wheel includes one crank sliding set pivoted thereon; a crank sliding set of the first eccentric wheel includes a first actuating rod pivoted thereon, and a crank sliding set of the second eccentric wheel includes a second actuating rod pivoted thereon, and another ends of the first actuating rod and the second actuating rod includes the connecting rod fixed thereon, one end of the connecting rod is connected with the first sliding block on the machine frame, the first sliding block drives the connecting rod to move vertically in a reciprocate manner.

5. The multi-linkage press as claimed in claim 1, wherein the two leveraged linkage assemblies of the at least two multi-link mechanisms include two first swing arms pivoted on the connecting rod and two second swing arms pivoted on the connecting rod, another ends of the two first swing arms are axially coupled with two first extensions and two second extensions, and the two first extensions and the two second extensions are pivoted on the machine frame, the two first swing arms include two third extensions axially connected therewith and defined between the connecting rod and the two first extensions, and the two second swing arms include two fourth extensions axially connected therewith and defined between the connecting rod and the two second extensions.

6. The multi-linkage press as claimed in claim 5, wherein the two first extensions re axially connected on two first fixing members of the machine frame, and the two second extensions are axially connected on two second fixing members of the machine frame.

7. The multi-linkage press as claimed in claim 1, wherein the sliding assembly includes a slidable body fixed on the machine frame.

8. The multi-linkage press as claimed in claim 1 further comprising a parallel four-link balancing mechanism including a counterweight member to keep operation in an opposite direction to the slidable body of the punch.

9. The multi-linkage press as claimed in claim 8, wherein the parallel four-link balancing mechanism a first peg and a second peg, both of which are axially connected on a lower end of the counterweight member, a third peg axially coupled with another end of the first peg, and a fourth axially joined with another end of the second peg, the third peg and the fourth peg are axially connected with the sliding assembly, and two pivot points of the first peg and the third peg are pivoted on a second sliding block for laterally sliding, and two pivot points of the second peg and the fourth peg are pivoted on a third sliding block for laterally sliding such that the counterweight member keeps operation in the opposite direction to the slidable body of the punch.
